(19) United States
(12) Patent Application Publication
(10) Pub. No.: US 2011/0274512 A1
(43) Pub. Date: Nov. 10, 2011

(54) Hub Lock

(76) Inventor: John Robert Neary, Kentville (CA)

(21) Appl. No.: 12/800,034

(22) Filed: May 7, 2010

(51) Int. Cl. F16B 39/00

(52) U.S. Cl. 411/259

(57) ABSTRACT

The following invention describes a compact, lightweight, economical means of attaching chain drive sprocket hubs securely to half axles assembly rotatable along a transverse axle rotation axis, found in all-terrain-vehicles or the like. The assembly comprises a half axle and sprocket hub each having a cross-hole corresponding in size and aligned with each other. The cross-hole in the half axle is threaded and a bolt passes through both the cross-hole in sprocket hub and the threaded cross-hole of the half axle. Axle/flange bearings are located on either side of the chain drive sprocket hub and the inner end of the half axle is threaded to accommodate a flanged nut.

### BACKGROUND OF THE INVENTION

Axles and attached chain drive sprockets found in all terrain vehicles or the like are constantly enduring heavy reversing loads making it difficult to keep the chain link drive sprocket hubs fixed firmly to the axle. Traditional keys and setscrews used in this application are almost impossible to keep tight and are difficult to remove when they become loose, burred, corroded or damaged. Shaft and drive hub splines are expensive and sensitive to corrosion. Taper lock hubs are also expensive, require extra space, add weight and are difficult to disassemble.

### SUMMARY OF THE INVENTION

The object of my invention as described is compact, lightweight, economical and also reduces the time and effort in assembly and disassembly of attaching a chain drive sprocket hub to and locking it to an axle.

### DESCRIPTION OF THE DRAWINGS

Although the characteristic features of the invention will be particularly pointed out in the claims, the invention itself and the manner in which it may be made and used may be better understood by referring to the following description and accompanying drawings, where like reference numerals refer to like parts throughout the several view of the drawings, in which

FIG. 1 is a perspective view of the assembly for axle/chain drive sprocket Hub Lock with axle/bearings found in all terrain vehicles or the like;

FIG. 2 shows an exploded view of the assembly depicted in FIG. 1;

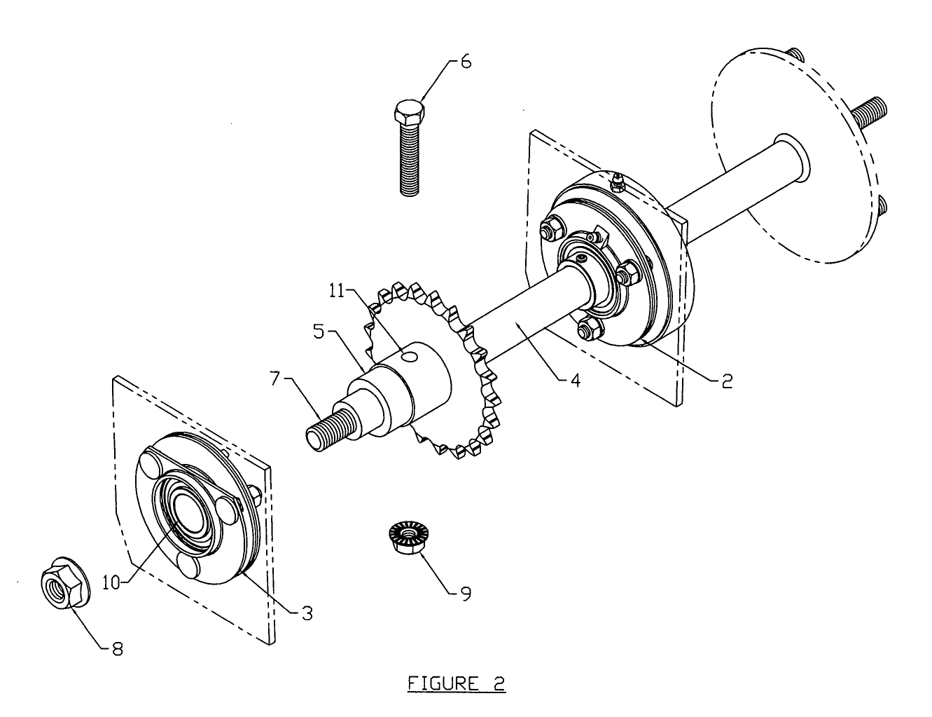

FIG. 3 is a longitudinal cross section taken along line X1-X1 , depicted in perspective, of FIG. 1;

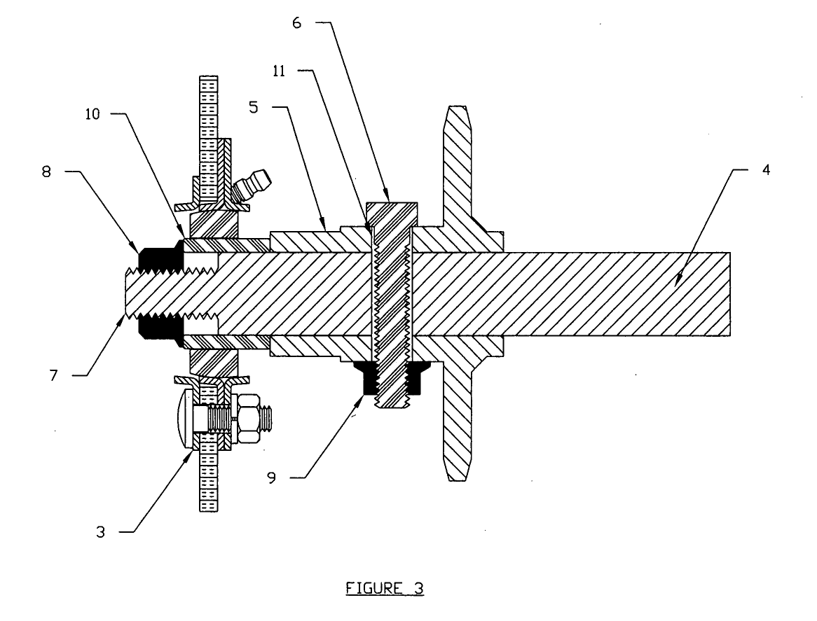

FIG. 4 is an exploded perspective view of a second embodiment for axle/chain drive sprocket Hub Lock found in all terrain vehicles or the like;

FIG. 5 is a longitudinal cross-section taken along line X1-X1, depicted in perspective, of FIG. 4;

FIG. 6 is an exploded perspective view of a third embodiment for axle/chain drive sprocket Hub Lock with a portion of the outside dimension of the axle reduced found in all terrain vehicle or the like;

FIG. 7 is a longitudinal cross-section taken along line X1-X1, depicted in perspective, of FIG. 6.

### DESCRIPTION OF THE PREFERRED EMBODIMENT

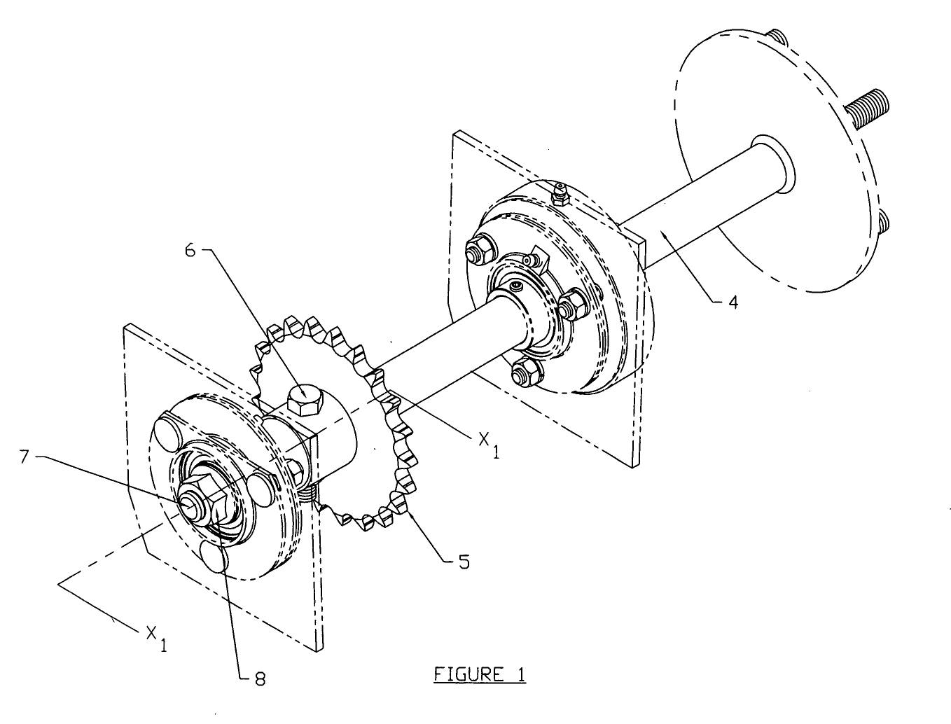

The accompanying drawings, as described above, illustrate a preferred embodiment of an assembly for an axle/chain drive sprocket hub. The following disclosure, describes a preferred embodiment of an axle/chain drive sprocket Hub Lock assembly rotatable along a transverse axle rotation axis and comprises the following assembly of component parts Reference from FIGS. 1,2 and 3 an axle flange/bearing 2, is bolted to an outer body panel (shown in dotted lines) of all terrain vehicles. A similar flange/bearing 3 bolted to an inner body panel (shown in dotted lines) found in all terrain vehicles. Axle 4 is installed from the outside of an outer body panel of all terrain vehicle through the chain drive sprocket hub 5. The chain drive sprocket hub 5 has a cross hole 11 aligned with a similar sized threaded cross hole through the axle 4. A bolt 6 passes through cross hole 11 of the chain drive sprocket hub 5 and threaded through the diametrically aligned cross hole 11 of the axle 4 and extends through and beyond the opposite side of the chain drive sprocket hub 5. Wherein a locknut with a serrated flange 9 is threaded on to bolt 6, securing the chain drive sprocket hub 5 to the axle 4.

The inside end of the axle 4, extends partially through the axle flange/bearing 3. The inner end of the axle, from the threaded cross hole 11 to where the end of axle threads begin, is less than the distance from the threaded crosshole to the inner end of the axle flange/bearing 3. (see arrow 10)

A top-lock type flange nut 8 is installed on the threaded end 7 of the axle 4. The flange of the top-lock type nut 8 has a flange with a larger outside diameter than the inside diameter of the bearing founded in the flange/bearing 3.

Tightening the bolt 6, flange nut 9 and top-lock type flange nut 8 creates a ridged, secure assembly and will prevent both lateral and rotational forces from loosening the chain drive sprocket drive hub 5 on the axle 4.

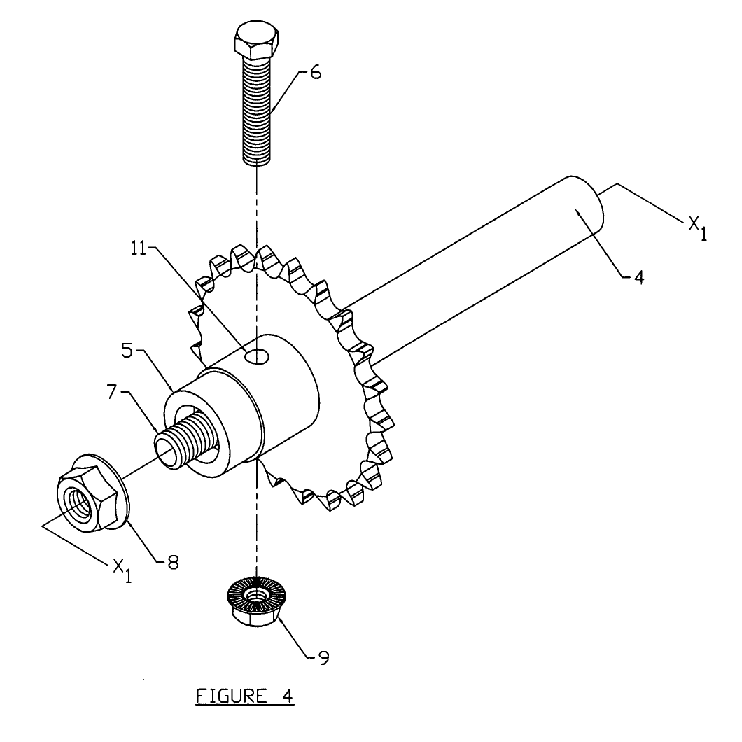

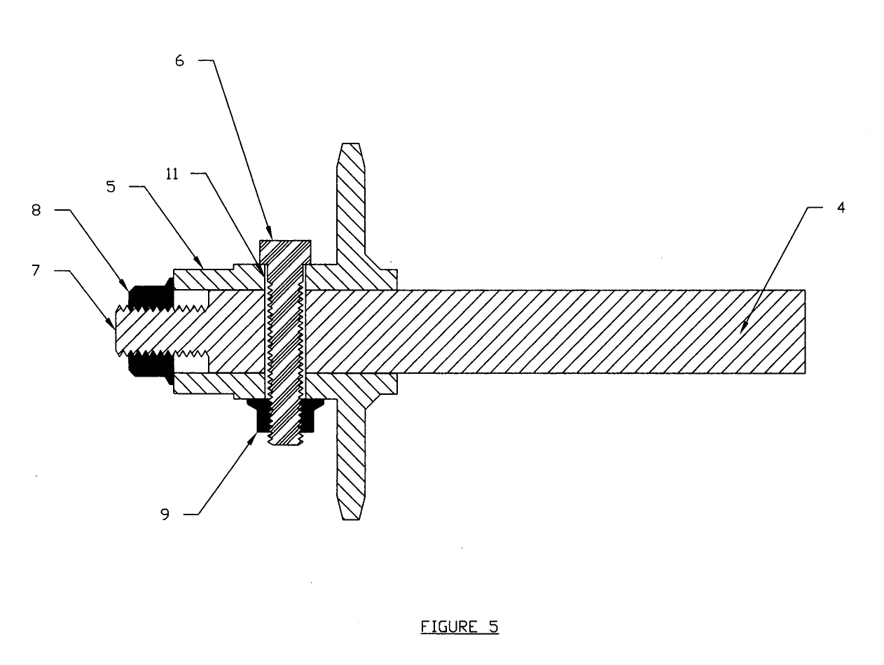

The accompanying drawings as described above, FIGS. 4 and 5 illustrates a second embodiment of an assembly for an axle/chain drive sprocket hub. The following disclosure, describes a second embodiment of an axle/chain drive sprocket Hub Lock assembly rotatable along a transverse axle rotation axis and comprises an assembly of an axle 4 and chain drive sprocket hub 5, wherein an axle 4 passes through a sprocket hub 5. The sprocket hub 5 has a cross hole 11 aligned with a similar size threaded cross hole through the axle 4. A bolt 6 passes through cross hole 11 of the sprocket hub 5 and threaded through the diametrically aligned cross hole 11 of the axle 4 and extends through and beyond the opposite side of the axle 4 and sprocket hub 5 wherein a locknut with a serrated flange 9 is threaded on to bolt 6, securing the chain drive sprocket hub 5 to the axle 4.

The end of the axle 4 extends partially through the sprocket hub 5. The end of the axle 4 from the threaded hole 11 to where the end of the axle threads 7 begins, is less than the distance from the threaded cross hole 11 to the outer end of the sprocket hub 5. A top-lock type flange nut 8 has a flange with a larger outside diameter than the inside diameter of the sprocket hub 5.

Tightening the bolt 6, flange nut 9 and top-lock type flange nut 8 creates a ridged, secure assembly and will prevent both lateral and rotational forces from loosening the chain drive sprocket drive hub 5 on the axle 4.

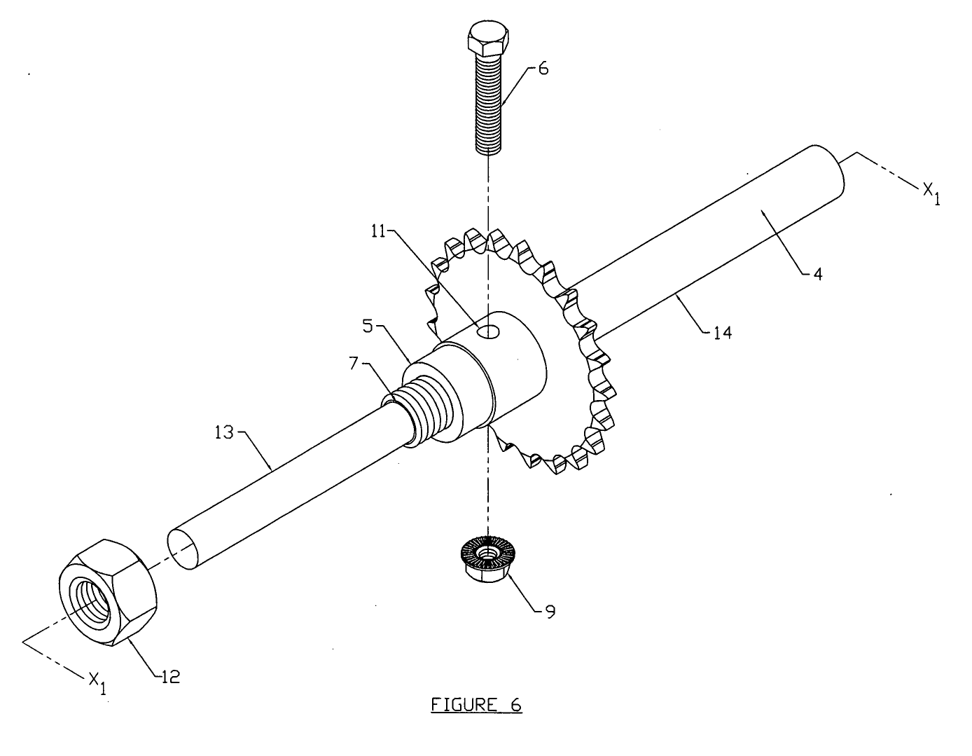

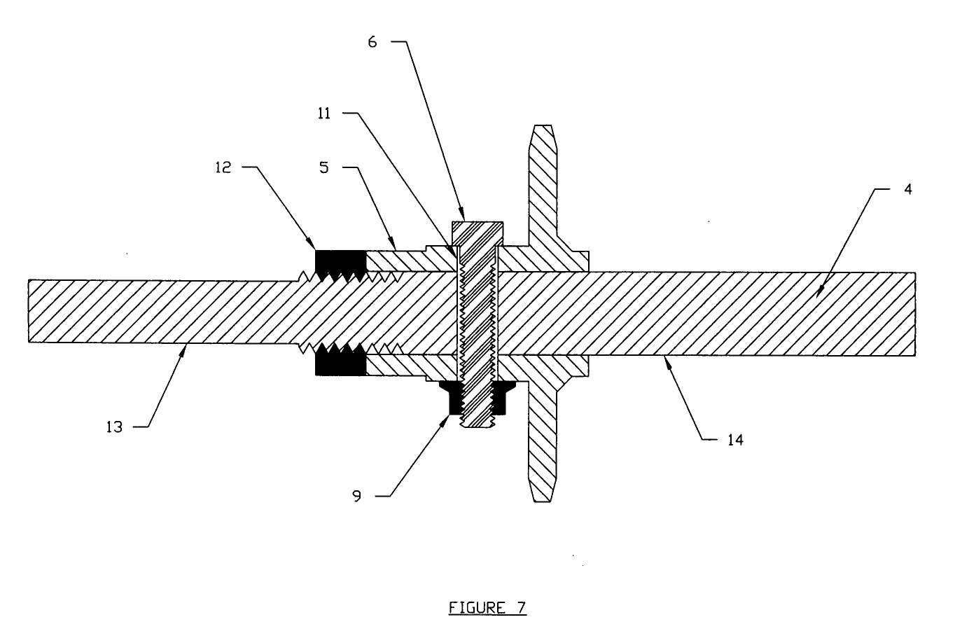

The accompanying drawings as described above, FIGS. 6 and 7 illustrates a third embodiment of an assembly for an axle/chain drive sprocket hub. The following disclosure, describes a third embodiment of an axle/chain drive sprocket hub lock assembly rotatable along a transverse axle rotation axis and comprises the following assembly of component parts, wherein a sprocket hub 5 is located along the mid-portion of an axle 4. The axle 4 has two outside dimensions, a section 13 and a larger outside dimension section 14. The larger outside dimension section 14 has a threaded end 7 where the section 13 and larger section 14 meet. The axle 4 passes through sprocket hub 5. The sprocket hub 5 has a cross hole 11 aligned with a similar size threaded cross hole through the axle 4. A bolt 6 passes through cross hole 11 of the sprocket hub 5 and threaded through the diametrically aligned cross hole 11 of the axle 4 and extends through and beyond the opposite side of the axle 4 and sprocket hub 5 wherein a locknut with a serrated flange 9 is threaded on to bolt 6, securing the chain drive sprocket hub 5 to the axle 4.

A portion of the threaded end 7 of the axle 4 extends through and just beyond the sprocket hub 5 (FIG. 7). A top lock type nut 12 is installed on the threaded end 7 of the axle 4 that extends beyond the sprocket hub 5. Tightening the bolt 6, flange nut 9 and top-lock type nut 12 creates a ridged, secure assembly and will prevent both lateral and rotational forces from loosening the chain drive sprocket drive hub 5 on the axle 4.

I claim:

1. An assembly of chain drive sprocket hub to an axle for an all terrain vehicle or the like:
comprising an axle assembly rotatable along a transverse axle rotation axis; a pair of flange/bearings for mounting said axle assembly: a drive sprocket hub is attached to said axle for rotating said axle assembly; a chain drive sprocket hub for transferring rotation power to said axle is attached by means of a bolt which passes through a cross hole located in said sprocket hub, threaded through said axle and then passes through the diametrically opposite cross hole of said sprocket hub: a locknut with a serrated flange is threaded on to said bolt securing the chain drive sprocket hub to the axle; a top lock type flange nut is tightened on the threaded end of said axle.

2. An assembly as described in claim 1 wherein the assembly comprises an axle passes through a sprocket hub and is attached by means of a bolt which passes through a cross hole located in said sprocket hub, threaded through said axle and then passes through the diametrically opposite cross hole of said sprocket hub: a locknut with a serrated flange is threaded on to said bolt securing the chain drive sprocket hub to the axle; a top lock type flange nut is tightened on the threaded end of said axle.

3. An assembly as described in claim 2 wherein the assembly comprises an axle passes through a sprocket hub located along the mid-portion of said axle which has two outside dimensions, the larger outside dimensions has a threaded end where the smaller and larger dimensions meet the chain drive sprocket is attached by means of a bolt which passes through a cross hole located in said sprocket hub, threaded through said axle and then passes through the diametrically opposite cross hole of said sprocket hub: a locknut with a serrated flange is threaded on to said bolt securing the chain drive sprocket hub to the axle; a top lock type flange nut is tightened on the threaded end of said axle.
